(19) United States
(12) Patent Application Publication
(10) Pub. No.: US 2026/0305564 A1
(43) Pub. Date: Oct. 8, 2026

(54) CONTROLLER FOR A MILKING PLANT, COMPUTER-IMPLEMENTED METHOD, COMPUTER PROGRAM AND NON-VOLATILE DATA CARRIER

(71) Applicant: DELAVAL HOLDING AB, Tumba (SE)

(72) Inventors: Jörgen ENICKL, Tumba (SE); Janusz FRANKOWSKI, Tumba (SE); Lars LILJEGREN, Tumba (SE); Marek MACHOWSKI, Tumba (SE)

(21) Appl. No.: 19/482,917

(22) PCT Filed: May 10, 2024
(86) PCT No.: PCT/SE2024/050449

§ 371 Date: Nov. 10, 2025

(30) Foreign Application Priority Data
May 12, 2023 (SE) 2350581-1

(51) Int. Cl. A01J 5/007; G08B 21/18

(52) U.S. Cl. CPC A01J 5/007; G08B 21/182

(57) ABSTRACT

A controller obtains pressure signals from pressure sensor devices in a milking plant during pressurization. Each pressure signal represents a function of time defining a respective measured pressure signature describing how a pressure level is developed over time in a particular component in the milking plant. The controller compares the measured pressure signature to a reference pressure signature for the component. The reference pressure signature represents a pressure signal obtained from a pressure sensor device during pressurization of the milking plant when the milking plant is tuned to fulfil a quality condition with respect to the component. If the measured pressure signature deviates from the reference pressure signature by more than a tolerable margin, the controller generates an alarm.

### TECHNICAL FIELD

The present invention relates generally to improving the utilization efficiency of a milking plant. Especially, the invention relates to a controller according to claim 1 and a corresponding computer-implemented method. The invention also relates to a computer program and a non-volatile data carrier storing such a computer program.

### BACKGROUND

Today's milking systems are highly complex installations in which a multitude of components and pieces of equipment must interact according to many well-tuned processes. To accomplish the intended functionality it is fundamental that the milking installation fulfills various pressure requirements, both on an overall system level and with respect to each part individually.

WO 2017/091126 shows a technical solution for cleaning a milk transporting conduit structure that involves introducing fluid and an amount of gas into the milk transporting conduit structure. Thus a temporary pressure increase is produced, which causes a slug of fluid to be formed in and forwarded through the milk transporting conduit structure. A sensor arrangement measures at least one parameter related to the slug, and repeatedly forwards updatings of the at least one measured parameter to a data processor. Based thereon, the data processor produces an indicator of at least one quality of the cleaning process. The indicator reflects a cross-sectional profile of the slug at one or more positions in the milk transporting conduit structure.

WO 2021/262069 describes how at least one operating pressure in a milking installation is monitored by a pressure sensor measuring values of a pressure level in a component of the milking installation. The pressure level is indicative of the at least one operating pressure to be monitored. A processing node generates monitoring data representing a series of measured values of the pressure level. The monitoring data contains temporal indicators designating a respective timestamp indicating a point in time when a value of the pressure level was measured. The temporal indicators serve as a basis for triggering at least one alarm, for example if a timestamp indicates that the pressure level was measured to a value outside of an acceptable range of values at the point in time indicated by the timestamp.

U.S. Pat. No. 6,089,242 discloses a dairy pipeline wash system for monitoring and controlling the wash cycle of a dairy harvesting facility. The system includes a user interactive data processor for receiving and storing wash parameters, monitoring wash conditions, comparing monitored wash conditions to wash parameters, and controlling wash conditions to comply with wash parameters. The dairy pipeline wash system may include a closed loop or fuzzy logic system to vary wash conditions as dairy pipeline conditions change.

Thus, solutions exist for monitoring various pressure levels in a milking system, especially in connection with cleaning. Due to the large number of pressurized components and conduits included in a milking system, it is however challenging to detect exactly where any leakages in the system are located.

### SUMMARY

The object of the present invention is therefore to offer a solution that solves the above problem and enables straightforward identification of any components that cause an undesired flow of fluids from and/or into a milking plant.

According to one aspect of the invention, the object is achieved by a controller for monitoring pressure levels in a milking plant. The controller is configured to obtain at least one pressure signal from at least one pressure sensor device in the milking plant during pressurization of the milking plant. The at least one pressure signal represents a function of time defining at least one measured pressure signature describing how a pressure level is developed over time in at least one component of the milking plant. The controller is further configured to compare the at least one measured pressure signature to at least one reference pressure signature for said at least one component. The at least one reference pressure signature represents at least one pressure signal obtained from the at least one pressure sensor device during pressurization of the milking plant when the milking plant is tuned to fulfil at least one quality condition with respect to said at least one component. If at least one of the at least one measured pressure signature deviates from the at least one reference pressure signature by more than a tolerable margin, the controller is configured to generate at least one alarm.

This controller is advantageous because it is capable of pinpointing any component in a milking plant that fails to comply with its specific pressure requirements either in terms of a pressure level, as such, the time required to reach a particular pressure level, or both, during predefined circumstances and when no milking is taking place. For example, the predefined circumstances may prevail in connection with starting a vacuum pump that is configured to provide a system pressure in the milking plant, or while cleaning the milking plant.

Specifically, the pressurization of the milking plant may be defined to comprise a measurement period extending from a starting time instance when said vacuum pump is started to a finishing time instance after a point time when the milking plant is pressurized when being tuned to fulfil the at least one quality condition with respect to said at least one component.

Preferably, the at least one reference pressure signature and the at least one measured pressure signature are registered in an idle state when no milking session is ongoing in the milking plant, or no cleaning procedure is being performed in the milking plant.

According to one embodiment of this aspect of the invention, the tolerable margin specifically defines a first threshold pressure level that must be reached before a first time limit. Here, the first pressure threshold level is below a steady-state pressure level of the reference pressure signature, and first time limit lies within a first acceptance period after a point in time when the reference pressure signature is at the steady-state pressure level. Consequently, a measured pressure level below the steady-state pressure level of the reference pressure signature may be accepted as well as a somewhat extended delay until this level is reached.

According to another embodiment of this aspect of the invention, the tolerable margin specifically defines a second pressure threshold level above the steady-state pressure level of the reference pressure signature. Here, the second pressure threshold level must not be reached earlier than a second time limit before the point in time when the reference pressure signature is at the steady-state pressure level. In other words, a pressure level above the steady-state pressure level of the reference pressure signature may be accepted. A somewhat shortened delay until this pressure level is reached may also be tolerated.

For example, the milking plant may contain multiple pressure sensor devices, which each is configured to produce a respective pressure signal representing a respective function of time defining a respective measured pressure signature describing how the pressure level is developed over time in a respective component of the milking plant. If the measured pressure signature for a particular one of the components deviates from the reference pressure signature by more than the tolerable margin for that component, the controller is preferably configured to generate an alarm that identifies said component. Of course, this is very helpful for a farmer who seeks to minimize the downtime for his/her milking plant.

According to one embodiment of this aspect of the invention, for each of the respective components of the milking plant, the controller is configured to compare a respective measured pressure signature to a respective reference pressure signature for the component in question, which respective reference pressure signature represents a pressure signal obtained from the component in question when the milking plant is tuned to fulfil at least one quality condition with respect to that component. Namely, typically, each component must be tested against a reference pressure signature tailored for that component. Especially, this is true if at least two of the respective components are of different types.

According to yet another embodiment of this aspect of the invention, it is presumed that the milking plant comprises a plurality of milking points, say 2-200, or 50-100. At least two of the multiple pressure sensor devices are configured to register a respective pressure signal defining a respective measured pressure signature describing how the pressure level is developed over time in a respective milk conduit of said two or more milking points when, in each teatcup of each of said two or more milking points a respective teatcup opening is blocked to prevent air to be sucked in while not being attached to an animal. The controller is here configured to generate the at least one alarm such that it identifies a particular one of the two or more milking points if the pressure signature describing how the pressure level is developed over time in the milk conduit of said identified milking point deviates from the reference pressure signature for said particular one of the two or more milking points by more than the tolerable margin. Consequently, milking points with pressure problems may be spotted in a straightforward manner in milking plants of all sizes.

According to another embodiment of this aspect of the invention, said multiple components of the milking plant comprise at least two pulsator devices. Here, a respective one of the pressure sensor devices is configured to register a respective pressure signal defining a respective measured pressure signature describing how the pressure level is developed over time in a respective one of at the least two pulsator devices. Further, the controller is configured to generate the at least one alarm such that it identifies a particular one of the at least two pulsator devices, if the pressure signature describing how the pressure level is developed over time in the identified pulsator device deviates from the reference pressure signature for the identified pulsator device by more than the tolerable margin. This allows swift discovery of any malfunctioning pulsator devices in the milking plant.

According to further embodiments of this aspect of the invention, said multiple components of the milking plant comprise an air intake adapted to allow air from the atmosphere into a milk line, an outlet of the milk line into a receiver tank, the receiver tank, a vacuum regulator configured to control a fluid pressure in a pressure tank in fluid connection with the receiver tank, and/or a vacuum pump configured to provide a system pressure in the milking plant. In these embodiments of the invention, a respective one of the multiple pressure sensor devices is configured to register a respective pressure signal defining a respective measured pressure signature describing how the pressure level is developed over time in the air intake adapted to allow air from the atmosphere into the milk line, the outlet of the milk line into the receiver tank, the receiver tank, the vacuum regulator configured to control the fluid pressure in the pressure tank in fluid connection with the receiver tank, and/or the vacuum pump configured to provide the system pressure in the milking plant respectively. Moreover, the controller is configured to generate the at least one alarm such that it identifies the air intake, the trombone, the outlet of the milk line into the receiver tank, the receiver tank, the vacuum regulator and/or the vacuum pump respectively, if the pressure signature describing how the pressure level is developed over time in the air intake, the trombone, the outlet of the milk line into the receiver tank, the receiver tank, the vacuum regulator and/or the vacuum pump respectively deviates from the reference pressure signature for the air intake, the trombone, the outlet of the milk line into the receiver tank, the receiver tank, the vacuum regulator and/or the vacuum pump respectively by more than the tolerable margin. Thus, it is possible to pinpoint pressure problems, e.g. related to leakages and/or cloggings, in all parts of a milking plant.

According to still another embodiment of this aspect of the invention, the controller is further configured to cause the particular one component identified by the at least one alarm to be disabled. Thus, for example, a milking point with a leaking pressure conduit may be taken out of service temporarily.

According to one embodiment of this aspect of the invention, the controller is configured to register a respective acceptable status for each component for which the measured pressure signature lies within the tolerable margin from the at least one reference pressure signature. Hence, a user may conveniently verify which components of his/her milking plants that operate satisfactory.

Further, for each of the components for which the measured pressure signature lies within the tolerable margin from the at least one reference pressure signature, the controller may be configured to obtain the pressure signal from the associated pressure sensor device during repeated occasions when the milking plant is pressurized, and record a respective trend for the at least one measured pressure signature. Here, the trend represents how the measured pressure signature develops throughout the repeated occasions when the milking plant is pressurized. As a result, it is possible to detect any components that are likely to fail before actual failure occurs.

According to another embodiment of this aspect of the invention, the controller is configured to obtain the at least one pressure signal from the at least one pressure sensor device while the milking plant is pressurized after completing a cleaning procedure in respect of the at least one component for which the at least one measured pressure signature describes how the pressure level is developed over time. Since all milking plants must be cleaned regularly, it is typically suitable to perform the proposed measurements in connection with restarting the plant after completing a cleaning procedure.

According to another aspect of the invention, the object is achieved by a computer-implemented method for monitoring pressure levels in a milking plant, which method is performed in processing unit of a controller. The method involves obtaining at least one pressure signal from at least one pressure sensor device in the milking plant during pressurization of the milking plant. The at least one pressure signal represents a function of time defining at least one measured pressure signature describing how a pressure level is developed over time in at least one component of the milking plant. The method also involves comparing the at least one measured pressure signature to at least one reference pressure signature for said at least one component. The at least one reference pressure signature represents at least one pressure signal obtained from the at least one pressure sensor device during pressurization of the milking plant when the milking plant is tuned to fulfil at least one quality condition with respect to said at least one component. Finally, the method involves generating at least one alarm, if at least one of the at least one measured pressure signature deviates from the at least one reference pressure signature by more than a tolerable margin. The advantages of this method, as well as the preferred embodiments thereof, are apparent from the discussion above with reference to the proposed system.

According to a further aspect of the invention, the object is achieved by a computer program loadable into a non-volatile data carrier communicatively connected to a processing unit. The computer program includes software for executing the above method when the program is run on the processing unit.

According to another aspect of the invention, the object is achieved by a non-volatile data carrier containing the above computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows a block diagram of a milking plant monitored by a controller according to one embodiment of the invention;

FIG. 2 shows graphs exemplifying reference and measured pressure signatures according to embodiments of the invention; and

FIG. 3 illustrates, by means of a flow diagram, the general method according to the invention.

### DETAILED DESCRIPTION

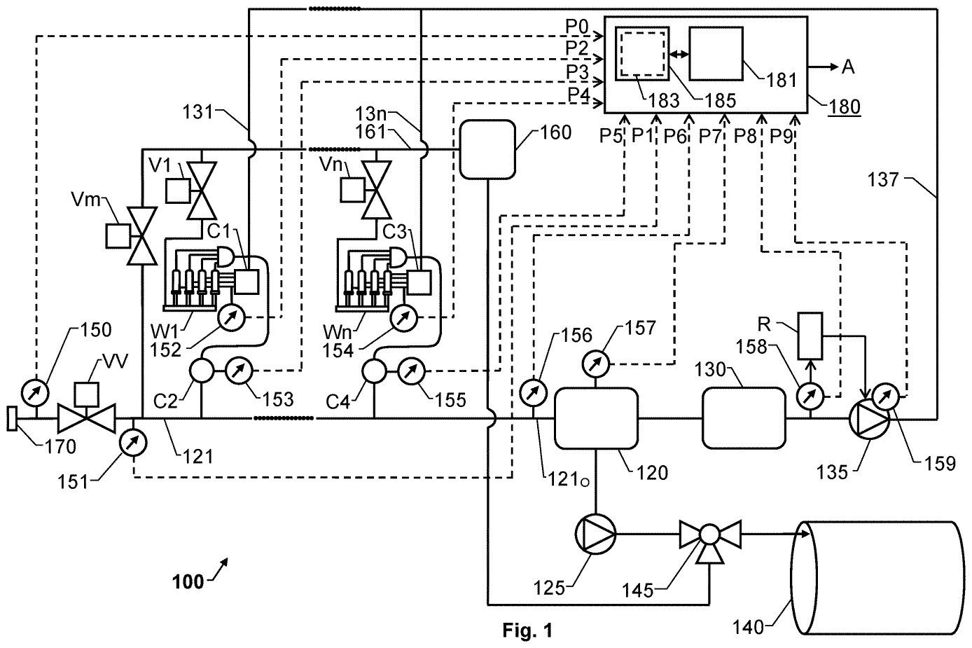

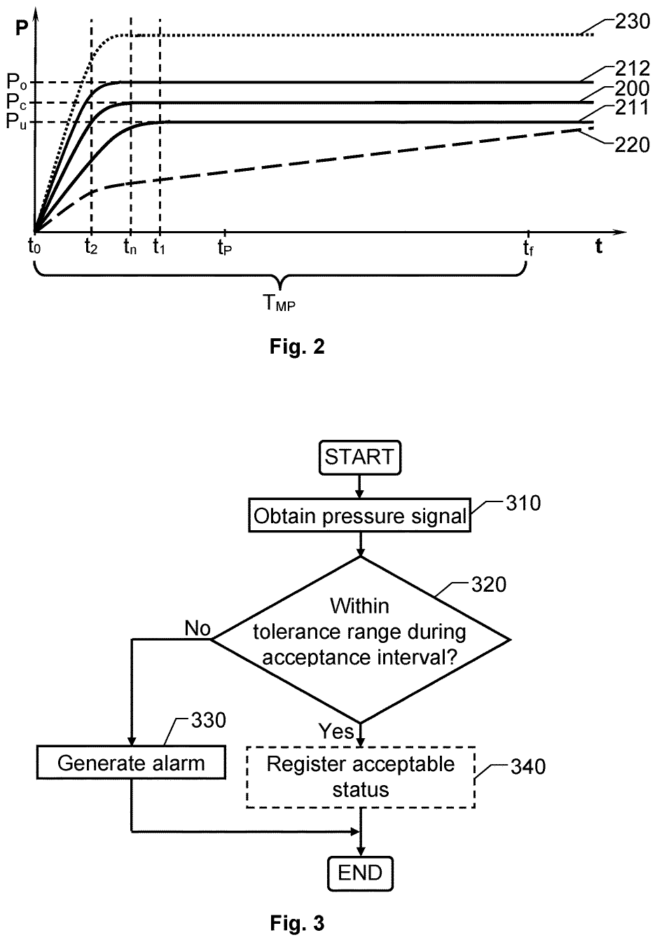

In FIG. 1, we see one example of milking plant 100. FIG. 2 shows a set of graphs exemplifying a reference pressure signature 200 and measured pressure signatures 211, 212, 220 and 230 respectively for a specific component in a milking plant during pressurization thereof. Thus, although FIG. 2 illustrates a generic example without any scales of magnitude on the pressure or time axes, according to the invention, each type of component in the milking plant 100 is associated with its own specific reference pressure signature 200 reflecting an ideal tuning of that component in terms of pressures that must be attained at various points in time.

The milking plant 100 is communicatively connected to a controller 180 arranged to monitor different pressure levels in the milking plant 100, where each pressure level is associated with a particular component.

The milking plant 100 contains a number of milking points via each of which milk is extractable from one dairy animal at the time. FIG. 1 schematically shows two milking points. However, a typical milking plant often contains a large number of milking points, say 20, 50, 100, or even more.

A vacuum pump 135 is configured to provide a system pressure to the milking plant 100. The system pressure is provided in a pulsation conduit 137, which, in turn, is further connected to each pulsator device via respective conduit branches 131 and 13n.

Each of the conduit branches 131 and 13n is further in fluid connection with a respective pulsator device C1 and C3, which is arranged to use the system pressure to cause repeated pressure pulsations between a vacuum pressure level and an atmospheric pressure level in a space between a teatcup liner and a teatcup shell in each teatcup in a set of teatcups, so that a dairy animal's teats being located in the teatcups are stimulated to eject milk. Pressure sensor devices, which will be discussed below, are arranged to measure the pressure level in a respective pulsator line between the respective pulsator devices C1 and C3 and said space between the teatcup liner and the teatcup shell. The ejected milk may be collected in a milk claw before being fed to a milk line 121 via a shut-off valve C2 and C4 respectively. Alternatively, if so-called quarter milking is performed, the ejected milk may be fed directly from each teatcup to the milk line 121 via a respective shut-off valve (not shown in FIG. 1).

According to the invention, both the reference pressure signature 200 and the measured pressure signatures are registered in an idle state of the milking plant, i.e. when neither any milking session is ongoing, nor a cleaning procedure is taking place.

When registering the reference pressure signature 200 and the measured pressure signatures in respect of the pulsator devices C1 and C3 atmospheric pressure prevails in the teatcups, and the pulsator devices C1 and C3 are activated while the milking plant is in the idle state during a measurement period, say of 5 to 10 seconds. Typically, this means that 5 to 10 pulsation cycles are completed during the measurement period.

FIG. 1 schematically shows a pressure sensor device 152 that is arranged to register a pressure signal P2 in the pulsator device C1, which is in fluid connection with the set of teatcups in a first milking point. In practice, a respective pressure sensor device is preferably arranged to register a respective pressure signal in each pulsator line to each of the teatcups. This means that the pressure sensor device 152 is actually represented by four sensor devices. Alternatively, a common pressure signal may be registered for a pair of teatcups, i.e. the pressure sensor device 152 corresponds to two sensor devices. Corresponding pressure sensor devices are arranged analogously in each of the other milking points. In FIG. 1, this is schematically illustrated by a pressure sensor device 154 being arranged to register a pressure signal P4 in the pulsator device C3 of a last milking point.

In FIG. 1, the sets of teatcups are arranged in a respective dish rack W1 and Wn in fluid connection with a dish line 161 via a respective remote controllable valve V1 and Vn. Thus, when the remote controllable valves V1 and Vn are opened, cleaning liquids may be fed from a cleaning-liquid container 160, via the dish line 161 and the valves V1 and Vn to the dish racks W1 and Wn, and further through each teatcup in the sets of teatcups. After that, the cleaning liquids are fed through the shut-off valves C2 and C4 respectively to the milk line 121, and into a receiver tank 120. Finally, a pump 125 may be employed to empty the cleaning liquids from the receiver tank 120, and back to the cleaning-liquid container 160 via a three-port valve 145.

The milk line 121 may be cleaned via a procedure in which a trombone VV is controlled to produce a so-called washing slug, which is fed through the milk line 121 into the receiver tank 120. The trombone VV, in turn, receives air from the atmosphere via an air inlet provided with a filter 170 for preventing particles from entering into the milk line 121.

When the milking plant 100 is operated to extract milk from dairy animals, milk from the animals is received in the teatcups, and fed via the shut-off valves C2 and C4 respectively to the milk line 121, via the receiver tank 120 and the pump 125, via the three-port valve 145.

According to the present invention, the pressure levels in one or more of the above-described components in the milking plant 100 may be monitored. To this aim, the controller 180 is configured to obtain at least one pressure signal from at least one pressure sensor device in the milking plant 100. Preferably, each of the pressure sensor devices contains a respective microprocessor that is configured to cause a measured pressure level to be sampled at a predefined rate. A particular sample rate is chosen for each pressure sensor device depending on the type of pressure signal to be registered by that pressure sensor device. For instance, pressure sensor devices 152 and 154 may operate at a sample rates around 1000 Hz.

A pressure sensor device 150 is arranged on the milk line 121 at the filter 170. The pressure sensor device 150 is configured to register a pressure level P0 associated with the air inlet and the filter 170, for example at a sample rate of around 1000 Hz. Thus, should for example the air inlet and/or the filter 170 be clogged, this would be reflected by the pressure level P0.

A pressure sensor device 151 is arranged on the milk conduit 121 next to the trombone VV. The pressure sensor device 151 is configured to register a pressure signal P1 indicating a pressure level in the milk line 121. The pressure sensor device 151 preferably operates at a sample rate of around 100 Hz.

A pressure sensor device 156 is arranged at an outlet 1200 of the milk line 121 into the receiver tank 120. Analogous to the pressure sensor device 151, the pressure sensor device 156 is configured to register a pressure signal P6 indicating a pressure level the milk line 121, however in an opposite end thereof relative to the pressure sensor device 151. Similar to the pressure sensor device 151, the pressure sensor device 156 preferably operates at a sample rate of approximately 100 Hz.

A pressure sensor device 157, for example operating at a sample rate around 10 Hz, is arranged in the receiver tank 120 to register a pressure signal P7 therein. As a result, it is possible to ensure that the receiver tank 120 attains an appropriate pressure level before milking is started.

A pressure sensor device 158 is arranged in a regulator loop of the vacuum pump 135, where the pressure sensor device 158 provides a pressure signal P8 to a regulator R, which, in turn, is configured to control the vacuum pump 135, such that the vacuum pump 135 provides a desired system pressure in the milking plant 100.

A pressure sensor device 159 is arranged in the vacuum pump 135 itself. The pressure sensor device 159 is configured to register a pressure signal P9 reflecting the system pressure in the milking plant 100. The pressure sensor devices 158 and 159 may operate at a sample rate around 1 Hz.

According to the invention, the controller 180 is configured to obtain one or more of the pressure signals P0, P1, P2, P3, P4, P5, P6, P7, P8 and/or P9 from the pressure sensor devices 150, 151, 152, 153, 154, 155, 156, 157, 158 and/or 159 during pressurization of the milking plant 100.

Referring to FIG. 2, the pressurization may specifically be defined as a measurement period T_{MP} extending from a starting time instance t₀ to a finishing time instance t_{f}. The starting time instance t₀ is a point in time when the vacuum pump 135 is started, and the finishing time instance t_{f} is a point in time after a point time t_{P} when the milking plant 100 is pressurized when being tuned to fulfil at least one quality condition with respect to at least one component therein in respect of which a pressure signal is monitored.

Each of the pressure signals P0, P1, P2, P3, P4, P5, P6, P7, P8 and P9 represents a function of time defining a respective measured pressure signature describing how a pressure level is developed over time in the components of the milking plant 100, e.g. the filter 170, the trombone VV, the pulsator devices C1 and C3, in milk conduits of the milking points, such as at the shut-off valves C2 and C4, the milk-pipe outlet 1210, the receiver tank 120, the regulator R and the vacuum pump 135 respectively. FIG. 2 shows examples of such measured pressure signatures in the form of graphs 211, 212, 220 and 230 respectively.

FIG. 2 also shows a graph 200 representing a reference pressure signature, which represents a pressure signal obtained from one of said pressure sensor devices 150, 151, 152, 153, 154, 155, 156, 157, 158 or 159 during pressurization of the milking plant 100 when the milking plant 100 is tuned to fulfil at least one quality condition with respect to components 170, VV, C1, C3, C2, C4, 121o, 120, R and 135 respectively.

For each component, the controller 180 is configured to compare the measured pressure signature, e.g. 211, 212, 220 or 230, to the corresponding reference pressure signature 200. If at least one of the measured pressure signatures, say 220 and 230, deviates from the reference pressure signature 200 by more than a tolerable margin, the controller 180 is configured to generate at least one alarm A, for example one alarm in respect of each component being associated with a measured pressure signature that is outside of said tolerable margin.

The tolerable margin may be defined in terms of a first threshold pressure level Pᵤ that must be reached before a first time limit t₁. To provide a tolerance interval, the first pressure threshold level Pᵤ is below a steady-state pressure level P_{c} of the reference pressure signature 200. Moreover, to provide a temporal tolerance, the first time limit t₁ lies within a first acceptance period after a point in time tₙ when the reference pressure signature 200 is at the steady-state pressure level P_{c}.

Alternatively, or additionally, the tolerable margin may be defined in terms of a second pressure threshold level Pₒ above the steady-state pressure level P_{c} of the reference pressure signature 200. Here, the second pressure threshold level Pₒ must not be reached earlier than a second time limit t₂ before the point in time tₙ when the reference pressure signature 200 is at the steady-state pressure level P_{c}. Namely, if the steady-state pressure level P_{c} is reached very quickly after pressurization, this typically indicates that the component in question is clogged and/or that a fluid flow there through is excessively restricted.

In FIG. 2, the measured pressure signatures 211 and 212 constitute examples of measured pressure signatures within the tolerable margin around the reference pressure signature 200. The measured pressure signature 230 constitutes an example of measured pressure signature above the reference pressure signature 200, and the measured pressure signature 220 constitutes an example of measured pressure signature below the reference pressure signature 200.

Although, technically, the invention is applicable to a scenario with just a single pressure sensor device, for example the sensor 159, which is configured to register the pressure signal P9, the invention is more useful if the controller 180 is configured to monitor multiple pressure levels in the milking plant 100 during pressurization.

According to one embodiment of the invention, if the measured pressure signature for one or more of said multiple components deviates from the reference pressure signature 200 by more than the tolerable margin, the controller 180 is configured to generate at least one alarm A that unambiguously identifies each of the one or more components whose measured pressure signature deviates from the reference pressure signature 200 by more than the tolerable margin.

Moreover, the controller 180 may be configured to cause each component identified by the alarm(s) A to be disabled. For example, if the pressure signal P2 from the pressure sensor device 153 defines a measured pressure signature describing a pressure level development over time in the milk conduit of the first milking point, which pressure development is outside of the tolerable margin around the reference pressure signature 200, the controller 180 may be configured to generate the alarm A such the alarm A identifies the first milking point, which includes the shut-off valve C2.

As a complement, the controller 180 may be configured to register a respective acceptable status for each of the components 170, VV, C1, C3, C2, C4, 1210, 120, R and/or 135 for which the measured pressure signature lies within the tolerable margin from the at least one reference pressure signature 200, such as 211 and 212 in FIG. 2.

Additionally, according to one embodiment of the invention, for each of the components for which the measured pressure signature lies within the tolerable margin from the at least one reference pressure signature 200, the controller 180 is configured to obtain the pressure signal P0, P1, P2, P3, P4, P5, P6, P7, P8 and/or P9 from the at least one pressure sensor device 150, 151, 152, 153, 154, 155, 156, 157, 158 and 159 respectively during repeated occasions when the milking plant 100 is pressurized, for instance after each cleaning procedure, and before milking is started, in a series of cleaning procedures in respect of the milking plant 100. Specifically, the controller 180 may be configured to obtain the pressure signals P0, P1, P2, P3, P4, P5, P6, P7, P8 and P9 from the pressure sensor devices 150, 151, 152, 153, 154, 155, 156, 157, 158 and 159 while the milking plant 100 is pressurized after completing a cleaning procedure in respect of the at least one component for which the measured pressure signature 211, 212, 220 and/or 230 describes how the pressure level is developed over time.

Further, in this embodiment of the invention, the controller 180 may be configured to record a respective trend for each of the measured pressure signatures, where the respective trend represents how the at least one measured pressure signature develops throughout the repeated occasions when the milking plant 100 is pressurized. Thereby, the controller 180 may detect a potential faulty component before this component actually fails, or malfunctions.

Specifically, according to different embodiments of the invention, the controller 180 may be configured to operate as described below.

The milking plant 100 is presumed to contain at least two milking points with a respective shut-off valve C2 and C4 respectively. At least two pressure sensor devices, here exemplified by 153 and 155 respectively, are configured to register a respective pressure signal defining a respective measured pressure signature describing how the pressure level is developed over time in a respective milk conduit of the milking points when, in each teatcup of each of these milking points, a respective teatcup opening is blocked to prevent air to be sucked in while not being attached to an animal. The pressure sensor devices 153 and 155 may operate at a sample rate around 10 Hz. The controller 180 is configured to generate the at least one alarm A, such that it identifies a particular one of the milking points if the pressure signature describing how the pressure level is developed over time in the milk conduit of the identified milking point deviates from the reference pressure signature 200 for that milking points by more than the tolerable margin.

Moreover, in addition to the vacuum pump 135 that is configured to provide a system pressure to the milking plant 100, the milking plant 100 may include: a receiver tank 120, an outlet 1200 of the milk line 121 into the receiver tank 120 and/or a vacuum regulator R configured to control a fluid pressure in a pressure tank 130 in fluid connection with the receiver tank 120. A respective sensor device 156, 157, 158 and 159 respectively is configured to register a respective pressure signal defining a respective measured pressure signature describing how the pressure level is developed over time in the outlet 1200 of the milk line 121 into the receiver tank 120, the receiver tank 120, the vacuum regulator R configured to control a fluid pressure in the pressure tank 130 in fluid connection with the receiver tank (120), and the vacuum pump respectively. The controller 180 is configured to generate the at least one alarm A, such that it identifies the outlet 1200 of the milk line 121 into the receiver tank 120, the receiver tank 120 itself, the vacuum regulator R and/or the vacuum pump respectively, if the pressure signature describing how the pressure level is developed over time in the outlet 1200 of the milk line(121 into the receiver tank 120, the receiver tank 120, the vacuum regulator R and/or the vacuum pump 135 respectively deviates from the reference pressure signature 200 for the outlet 1200 of the milk line 121 into the receiver tank 120, the receiver tank 120, the vacuum regulator R and/or the vacuum pump by more than the tolerable margin.

It is generally advantageous if the controller 180 is configured to effect the above-described procedure by executing a computer program. Therefore, the controller 180 may include a memory unit 183, i.e. non-volatile data carrier, storing a computer program 185, which, in turn, contains software for making processing circuitry in the form of a processor 181 in the controller 180 execute the actions mentioned in this disclosure when the computer program 185 is run on the processor 181.

In order to sum up, and with reference to the flow diagram in FIG. 3, we will now describe the computer-implemented method according to the invention which is performed in the processing unit 181 of the controller 180.

In a first step 310, a pressure signal is obtained, from a pressure sensor device in the milking plant. The pressure signal represents a function of time that defines a measured pressure signature describing how a pressure level is developed over time in a particular component of the milking plant. Thus, in practice, a large number of pressure signals are obtained in parallel-one pressure signal for each component.

For each measured pressure signature, a subsequent step 320 compares the measured pressure signature to a reference pressure signature for the component in question. Here, the reference pressure signature represents a pressure signal obtained from the pressure sensor device during pressurization of the milking plant when the milking plant is tuned to fulfil at least one quality condition with respect to component in question.

If the measured pressure signature deviates from the reference pressure signature by more than a tolerable margin, an alarm is generated in a step 330 following step 320.

Otherwise, i.e. if the measured pressure signature lies within the tolerable margin from the reference pressure signature, the procedure ends. However, before that, an acceptable status for the component in question may be registered in a step 340.

After step 330, the procedure ends.

The process steps described with reference to FIG. 3 may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal, which may be conveyed, directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. A controller for monitoring pressure levels in a milking plant, which controller is configured to:
obtain at least one pressure signal from at least one pressure sensor device in the milking plant during pressurization of the milking plant, the at least one pressure signal representing a function of time defining at least one measured pressure signature describing how a pressure level is developed over time in at least one component of the milking plant,
compare the at least one measured pressure signature to at least one reference pressure signature for said at least one component, which at least one reference pressure signature represents at least one pressure signal obtained from the at least one pressure sensor device during pressurization of the milking plant when the milking plant is tuned to fulfil at least one quality condition with respect to said at least one component, and
generate at least one alarm if at least one of the at least one measured pressure signature deviates from the at least one reference pressure signature by more than a tolerable margin.

2. The controller according to claim 1, wherein the at least one reference pressure signature and the at least one measured pressure signature are registered in an idle state when neither a milking session is ongoing in the milking plant, nor a cleaning procedure is being performed in the milking plant.

3. The controller according to claim 1, wherein the tolerable margin comprises a first threshold pressure level that must be reached before a first time limit, which first pressure threshold level is below a steady-state pressure level of the reference pressure signature, and which first time limit lies within a first acceptance period after a point in time when the reference pressure signature is at the steady-state pressure level.

4. The controller according to claim 1, wherein the tolerable margin comprises a second pressure threshold level above a steady-state pressure level of the reference pressure signature, which second pressure threshold level must not be reached earlier than a second time limit before a point in time when the reference pressure signature is at the steady-state pressure level.

5. The controller according to claim 1, wherein the milking plant comprises multiple pressure sensor devices which each is configured to produce a respective pressure signal representing a respective function of time defining a respective measured pressure signature describing how the pressure level is developed over time in a respective component of the milking plant.

6. The controller according to claim 5, wherein, for each of said respective components of the milking plant, the controller is configured to compare a respective measured pressure signature to a respective reference pressure signature for the component in question, which respective reference pressure signature represents a pressure signal obtained from the component in question when the milking plant is tuned to fulfil at least one quality condition with respect to that component.

7. The controller according to claim 6, wherein at least two of said respective components of the milking plant are of different types.

8. The controller according to claim 5, wherein, if the measured pressure signature for a particular one of said multiple components deviates from the reference pressure signature by more than the tolerable margin for said particular one component, the controller is configured to generate the at least one alarm such that said particular one component is identified by the at least one alarm.

9. The controller according to claim 5, wherein said multiple components of the milking plant comprise two or more milking points,
at least two of the multiple pressure sensor devices are configured to register a respective pressure signal defining a respective measured pressure signature describing how the pressure level is developed over time in a respective milk conduit of said two or more milking points when, in each teatcup of each of said two or more milking points a respective teatcup opening is blocked to prevent air to be sucked in while not being attached to an animal, and
the controller is configured to generate the at least one alarm such the at least one alarm identifies a particular one of the two or more milking points if the pressure signature describing how the pressure level is developed over time in the milk conduit of said identified milking point deviates from the reference pressure signature for said particular one of the two or more milking points by more than the tolerable margin.

10. The controller according to claim 5, wherein said multiple components of the milking plant comprise: an air intake adapted to allow air from the atmosphere into a milk line, and
at least one of the multiple pressure sensor devices is configured to register a pressure signal defining a measured pressure signature describing how the pressure level is developed over time in the air intake, and
the controller is configured to generate the at least one alarm such the at least one alarm identifies the air intake, if the pressure signature describing how the pressure level is developed over time in the air intake deviates from the reference pressure signature for the air intake by more than the tolerable margin.

11. The controller according to claim 5, wherein said multiple components of the milking plant comprise at least two pulsator devices,
a respective one of the multiple pressure sensor devices is configured to register a respective pressure signal defining a respective measured pressure signature describing how the pressure level is developed over time in a respective one of at the least two pulsator devices, which respective pressure signal is registered while the milking plant is in an idle state when neither milking nor cleaning is in progress, atmospheric pressure prevails in its teatcups, and the pulsator devices are activated during a measurement period, and
the controller is configured to generate the at least one alarm such that the at least one alarm identifies a particular one of the at least two pulsator devices, if the pressure signature describing how the pressure level is developed over time in the identified pulsator device deviates from the reference pressure signature for the identified pulsator device by more than the tolerable margin.

12. The controller according to claim 5, wherein said multiple components of the milking plant comprise at least one of: a receiver tank, an outlet of the milk line into the receiver tank, a vacuum regulator configured to control a fluid pressure in a pressure tank in fluid connection with the receiver tank, and a vacuum pump configured to provide a system pressure in the milking plant
a respective one of the multiple pressure sensor devices is configured to register a respective pressure signal defining a respective measured pressure signature describing how the pressure level is developed over time in the outlet of the milk line into the receiver tank, the receiver tank, the vacuum regulator configured to control a fluid pressure in the pressure tank in fluid connection with the receiver tank, and/or the vacuum pump respectively, and
the controller is configured to generate the at least one alarm such the at least one alarm identifies the outlet of the milk line into the receiver tank, the receiver tank, the vacuum regulator configured to control a fluid pressure in the pressure tank in fluid connection with the receiver tank and/or the vacuum pump respectively, if the pressure signature describing how the pressure level is developed over time in the outlet of the milk line into the receiver tank, the receiver tank, the vacuum regulator configured to control a fluid pressure in the pressure tank in fluid connection with the receiver tank, and/or the vacuum pump respectively deviates from the reference pressure signature for the outlet of the milk line into the receiver tank, the receiver tank, the vacuum regulator configured to control a fluid pressure in the pressure tank in fluid connection with the receiver tank and/or the vacuum pump by more than the tolerable margin.

13. The controller according to claim 5, being configured to register a respective acceptable status for each of said at least one component for which the at least one measured pressure signature lies within the tolerable margin from the at least one reference pressure signature for the component in question.

14. The controller according to claim 13, wherein, for each of said at least one component for which the at least one measured pressure signature lies within the tolerable margin from the at least one reference pressure signature, the controller is further configured to:
obtain the at least one pressure signal from the at least one pressure sensor device during repeated occasions when the milking plant (100) is pressurized, and
record at least one trend for the at least one measured pressure signature, which at least one trend represents how the at least one measured pressure signature develops throughout the repeated occasions when the milking plant is pressurized.

15. The controller according to claim 1, wherein the controller is configured to obtain the at least one pressure signal from the at least one pressure sensor device while the milking plant is pressurized after completing a cleaning procedure in respect of the at least one component for which the at least one measured pressure signature describes how the pressure level is developed over time, and before a milking session is initiated.

16. The controller according to claim 1, wherein the pressurization of the milking plant is defined to comprise measurement period extending:
from a starting time instance when a vacuum pump is started, which vacuum pump is configured to provide a system pressure in the milking plant,
to a finishing time instance after a point time when the milking plant is pressurized when being tuned to fulfil the at least one quality condition with respect to said at least one component.

17. The controller according to claim 1, wherein the controller is configured to cause the particular one component identified by the at least one alarm to be disabled.

18. A computer-implemented method for monitoring pressure levels in a milking plant, which method is performed in a processing unit of a controller, the method comprising:
obtaining at least one pressure signal from at least one pressure sensor device in the milking plant during pressurization of the milking plant, the at least one pressure signal representing a function of time defining at least one measured pressure signature describing how a pressure level is developed over time in at least one component of the milking plant,
comparing the at least one measured pressure signature to at least one reference pressure signature for said at least one component, which at least one reference pressure signature represents at least one pressure signal obtained from the at least one pressure sensor device during pressurization of the milking plant when the milking plant is tuned to fulfil at least one quality condition with respect to said at least one component, and
generating at least one alarm if at least one of the at least one measured pressure signature deviates from the at least one reference pressure signature by more than a tolerable margin.

19. A non-transitory computer-readable medium configured for storing a computer program, the computer program comprising commands which cause a processing unit to execute the method according to claim 18.

20. (canceled)
